(19) United States
(12) Patent Application Publication
(10) Pub. No.: US 2014/0314363 A1
(43) Pub. Date: Oct. 23, 2014

(54) INNER RING FOR A SPHERICAL ROLLER BEARING ASSEMBLY WITH INDUCTION ANNEALING AND METHOD THEREOF

(71) Applicant: Schaeffler Technologies GmbH & Co. KG, Herzogenaurach (DE)

(72) Inventors: Rocco Docimo, Stamford, CT (US); Mark E. Cochran, Oronogo, MO (US); Justin Clement, Granby, MO (US); Shawn Pierce, Fort Mill, SC (US); Matthew Thompson, Granby, MO (US)

(73) Assignee: Schaeffler Technologies GmbH & Co. KG, Herzogenaurach (DE)

(21) Appl. No.: 14/254,496

(22) Filed: Apr. 16, 2014

Related U.S. Application Data
(60) Provisional application No. 61/814,418, filed on Apr. 22, 2013.

(51) Int. Cl. F16C 33/62; F16C 33/64

(52) U.S. Cl. CPC F16C 33/62; F16C 33/64
USPC 384/569; 148/559

(57) ABSTRACT

An inner ring for a bearing, including: a first portion having a first hardness; and a second portion including an axial end of the inner ring with an axial circumferential edge, a slot for receiving a mounting or fastening device, or a hole for receiving a mounting fastener, an inner portion axially between the first portion and the slot or hole, and an outer portion axially between the slot or hole and the axial circumferential edge. At least one of the inner or outer portions has a second hardness less than the first hardness.

### CROSS-REFERENCE TO RELATED APPLICATIONS

This application claims the benefit under 35 U.S.C. §119(e) of U.S. Provisional Patent Application No. 61/814,418, filed Apr. 22, 2013, which application is incorporated herein by reference in its entirety.

### TECHNICAL FIELD

The present disclosure relates to an inner ring for a roller bearing assembly, in particular an inner ring for a spherical roller bearing assembly with a first portion for receiving the roller bearings and a second portion for mounting the inner ring. The second portion is annealed to have a hardness less the first portion.

### BACKGROUND

It is known to harden an inner ring for a bearing assembly to reduce wear due to contact of the inner ring with rolling elements in the assembly. However, the hardening in portions of the inner ring operated upon to form features (for example, slot or hole) for mounting the inner ring can result in fracturing, cracking, or weakening of the portions as a result of the operations, reducing durability and causing early failure of the inner ring. Further, cracking, fracturing, or other failure of the mounting or second portion can occur during mounting or servicing operations.

Hardness of materials can be measured. For bearing steels there are a variety of measurement systems, including Vickers (HV), Brinell (BHN) and Rockwell (HRB or HRC) hardness. In general, as hardness of a material, such as bearing steel, increases so does brittleness (i.e. the material is more susceptible to sudden fractures when stressed). It is typically advantageous to have a hard material at areas of high surface stress, such as at the contact area between a rolling element and a raceway of a bearing assembly. Conversely, it is typically advantageous to have a less hard material at areas of impact or sudden stress change, such as at mounting surfaces or mechanical components subject to cantilevered loads. In some applications a combination of high surface hardness, to resist penetration and carry high load, and relative interior ductility (i.e. lower hardness) to allow some bending or flexure to occur, can be used to address a particular operating regime.

### SUMMARY

According to aspects illustrated herein, there is provided an inner ring for a bearing, including: a first portion having a first hardness; and a second portion including an axial end of the inner ring with an axial circumferential edge, a slot for receiving a mounting or fastening device, or a hole for receiving a mounting fastener, an inner portion axially between the first portion and the slot or hole, and an outer portion axially between the slot or hole and the axial circumferential edge. At least one of the inner or outer portions has a second hardness less than the first hardness.

According to aspects illustrated herein, there is provided a bearing assembly, including an inner race including: an inner ring including: a first portion having a first hardness; and a second portion including: an axial end of the inner ring with an axial circumferential edge; a slot for receiving a snap ring or other mounting device, or a hole for receiving a mounting fastener; an inner portion axially between the first portion and the slot or hole; and an outer portion axially between the slot or hole and the axial circumferential edge; an outer ring; and a plurality of rolling elements in contact with the first portion and the outer ring and radially disposed between the first portion and the outer ring. At least one of the inner or outer portions has a second hardness less than the first hardness.

According to aspects illustrated herein, there is provided a method of fabricating an inner race, including: forming the inner race; hardening the inner race to a first hardness; annealing a first portion of the inner race to have a second hardness, less than the first hardness, while leaving a second portion of the inner race with the first hardness; and forming in the first portion a slot for receiving a snap ring or other mounting device, or a hole for receiving a mounting fastener.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a cross-sectional view of a bearing assembly with an inner race with a slot for receiving a mounting device;

FIG. 3 is a perspective view of an inner race with a slot for receiving a mounting device;

FIG. 4 is a cross-sectional view of a bearing assembly with an inner race with a hole for receiving a mounting fastener; and,

FIG. 5 is a table of hardness testing results for the inner race shown in FIG. 3.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

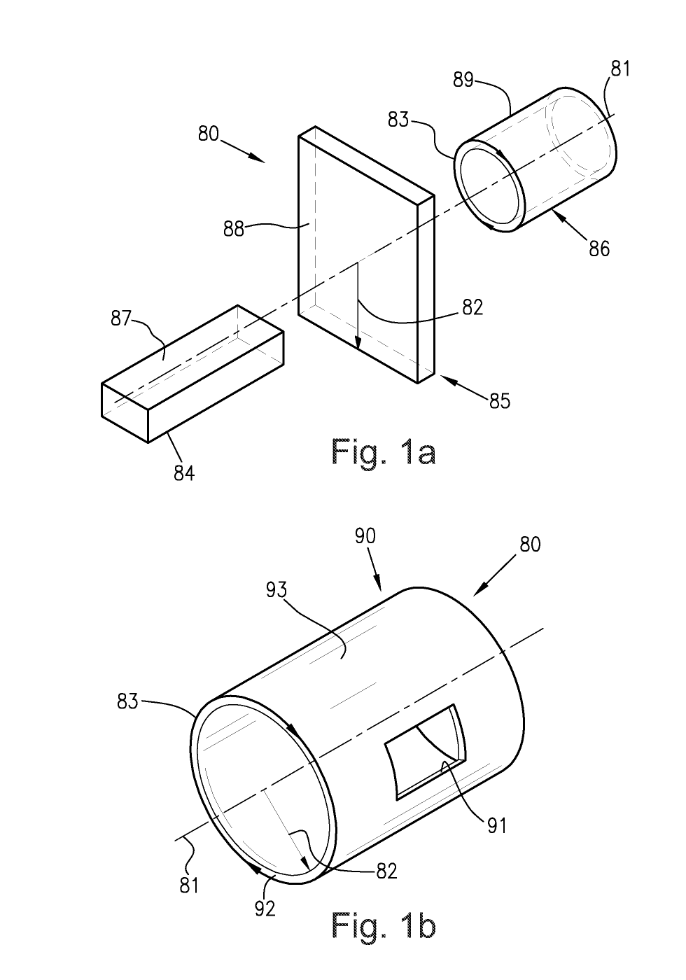

FIG. 1A is a perspective view of cylindrical coordinate system 80 demonstrating spatial terminology used in the present application. The present disclosure is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is a circumferential surface.

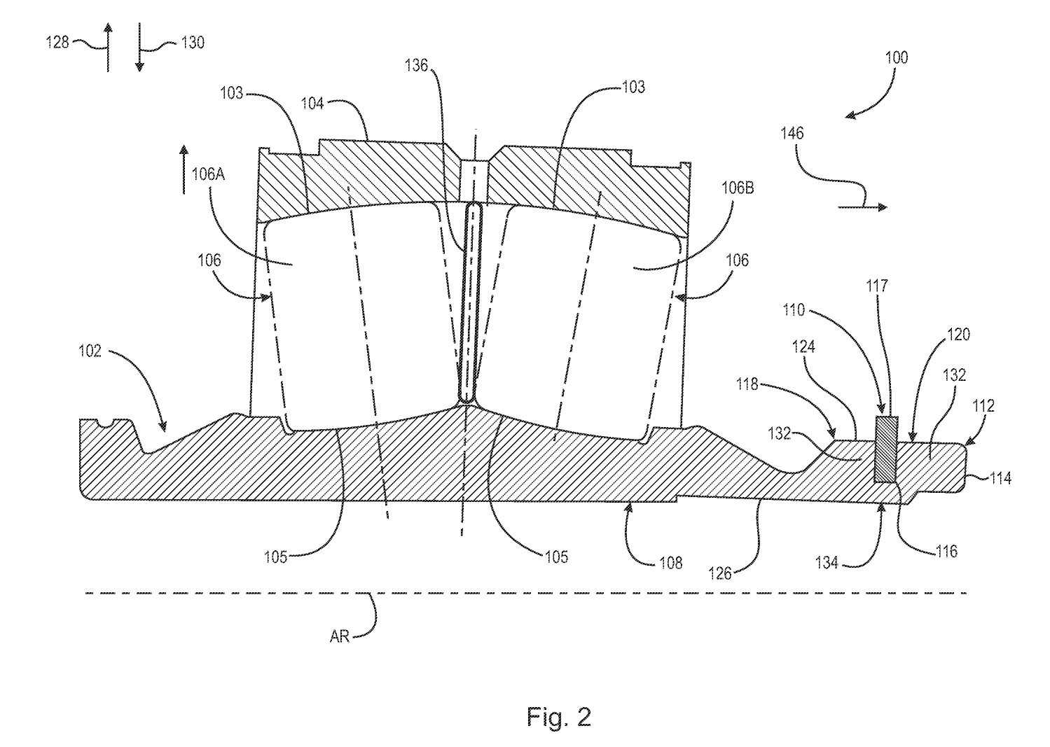

FIG. 2 is a cross-sectional view of bearing assembly 100 with a slot for receiving a mounting device.

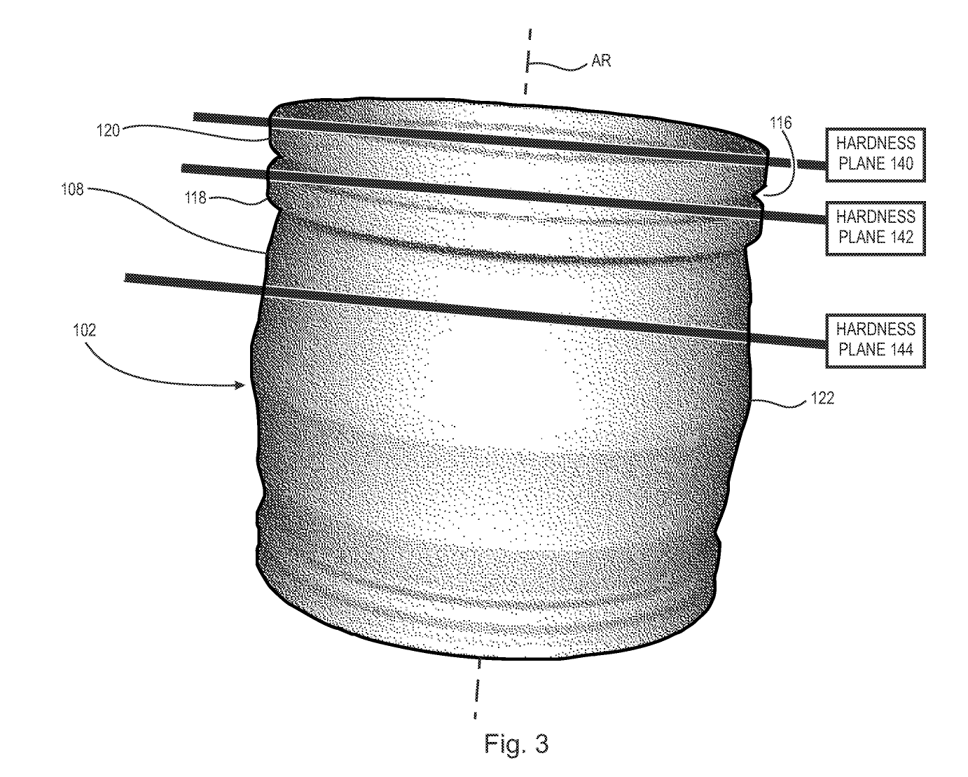

FIG. 3 is a perspective view of inner race 102 with a slot for receiving a mounting device. The following should be viewed in light of FIGS. 2 and 3. Assembly 100 includes inner ring 102, outer ring 104, and plurality of rolling elements 106 radially disposed between rings 102 and 104, circumferentially disposed about inner ring 102, and in contact with races 103 and 105 of rings 102 and 104, respectively. Note that the terms “radial,” “axial,” and “circumferential” are with respect to axis of rotation AR for assembly 100. Ring 102 includes portion 108 having a first hardness and portion 110 including axial end 112 of the inner ring with axial circumferential edge 114. Slot 116, for receiving a snap ring or other mounting device, such as snap ring 117, is located in portion 110. Portion 110 includes inner portion 118 axially between portion 108 and slot 116, and outer portion 120 axially between slot 116 and axial circumferential edge 114. At least one of portions 118 or 120 has a second hardness less than the first hardness. In an example embodiment, each of portions 118 or 120 has the second hardness.

In an example embodiment, portion 108 includes surface 122 (not labeled in figure) receiving/contacting plurality of rolling elements 106 and having the first hardness.

Portion 118 includes surfaces 124 and 126, facing in opposite radial directions 128 and 130, respectively. Portion 118 includes interior portion 132 radially aligned with and radially disposed between surfaces 124 and 126. In an example embodiment, each of surfaces 124 and 126 has the second hardness. In an example embodiment, portion 132 has the second hardness. In an example embodiment, each of surfaces 124 and 126 and portion 132 has the second hardness.

Portion 110 includes radial portion 134 radially aligned with the slot. In an example embodiment, portion 134 has the second hardness. In an example embodiment, rolling elements 106 are spherical rollers. In an example embodiment, rolling elements 106 includes a group of spherical rollers 106A circumferentially disposed about inner ring 102 and a group of spherical rollers 106B circumferentially disposed about inner ring 102 and axially separated from spherical rollers 106A. No cage is shown in FIG. 2, however, it is understood that a cage may be inserted to separate rolling elements 106A and 106B. It is further contemplated by the present invention that rolling elements 106A and 106B may comprise any of a number of rolling element types, including, but not limited to spherical rollers, as shown, balls, tapered rollers and cylindrical rollers.

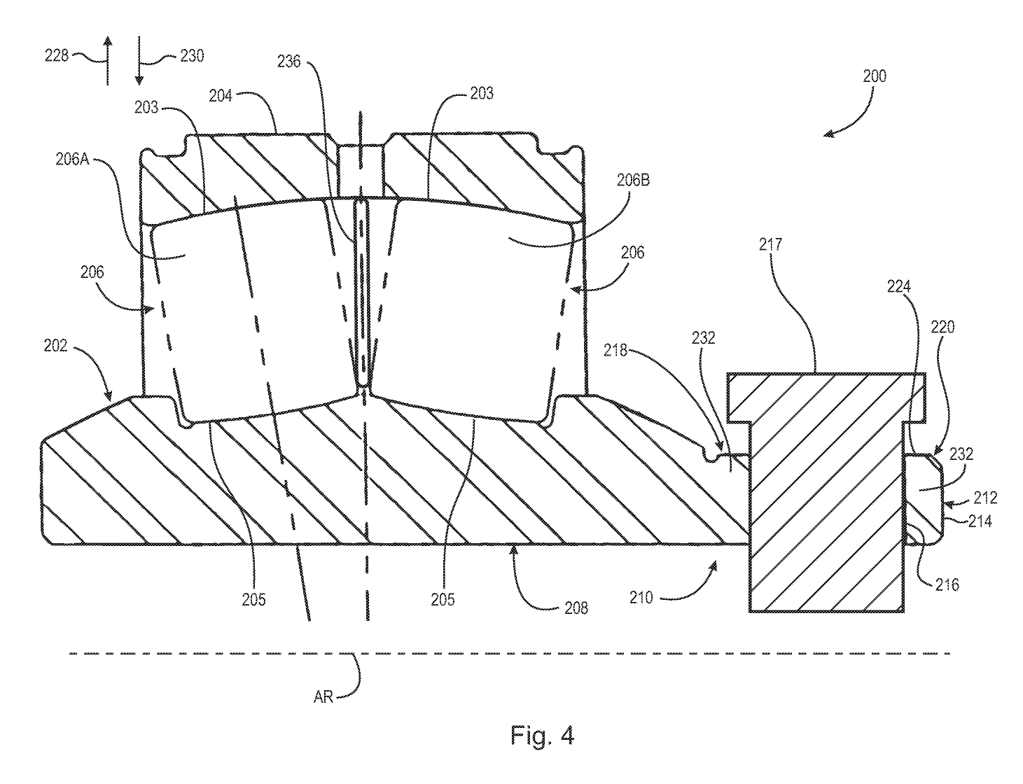

FIG. 4 is a cross-sectional view of bearing assembly 200 with inner ring 202 with a hole for receiving a mounting fastener. Assembly 200 includes inner ring 202, outer ring 204, and plurality of rolling elements 206 radially disposed between rings 202 and 204 and in contact with races 203 and 205 of rings 202 and 204, respectively. Note that the terms “radial,” “axial,” and “circumferential” are with respect to axis of rotation AR for assembly 200. Ring 202 includes portion 208 having a first hardness and portion 210 including axial end 212 of the inner ring with axial circumferential edge 214. Hole 216, for receiving a mounting fastener, such as threaded fastener 217, is located in portion 210. Portion 210 includes inner portion 218 axially between portion 208 and hole 216, and outer portion 220 axially between hole 216 and axial circumferential edge 214. At least one of portions 218 or 220 has a second hardness less than the first hardness. In an example embodiment, each of portions 218 or 220 has the second hardness.

In an example embodiment, portion 208 includes surface 222 receiving/contacting plurality of rolling elements 206 and having the first hardness. Portion 218 includes surfaces 224 and 226, facing in opposite radial directions 228 and 230, respectively. Portion 218 includes interior portion 232 radially aligned with and radially disposed between surfaces 224 and 226. In an example embodiment, each of surfaces 224 and 226 has the second hardness. In an example embodiment, portion 232 has the second hardness. In an example embodiment, each of surfaces 224 and 226 and portion 232 has the second hardness.

In an example embodiment, rolling elements 206 are rollers. In an example embodiment, rolling elements 206 includes a group of rollers 206A circumferentially disposed about inner ring 202 and a group of rollers 206B circumferentially disposed about inner ring 202 and axially separated from rollers 206A. No cage is shown in FIG. 4, however, it is understood that a cage may be inserted to separate rolling elements 206A and 206B. It is further contemplated by the present invention that rolling elements 206A and 206B may comprise any of a number of rolling element types, including, but not limited to spherical rollers, as shown, balls, tapered rollers and cylindrical rollers.

The following should be viewed in light of FIGS. 2 through 4. The following describes a method for fabricating an inner ring for a bearing assembly. Although the method is presented as a sequence of steps for clarity, no order should be inferred from the sequence unless explicitly stated. A first step forms the inner ring, such as ring 102 or 202. A second step hardens the inner ring to a first hardness. A third step anneals a first portion of the inner race, such as portion 110 or 210, to have a second hardness, less than the first hardness, while leaving a second portion of the inner race, such as portion 108 or 208, with the first hardness. A fourth step forms in the first portion a slot, such as slot 116, for receiving a mounting device, or a hole, such as hole 216 for receiving a mounting fastener.

The first portion includes an axial end of the inner race, such as 112 or 212, with an axial circumferential edge, such as 114 or 214. The second portion includes a surface, such as surface 122 or 222, arranged to contact a plurality of rolling elements. The first portion includes surfaces, such as surfaces 124/126 or 224/226, facing in opposite radial directions having the second hardness. Forming the slot includes forming the slot in the one of the surfaces for the first portion. Forming the hole includes connecting the surfaces for the first portion with the hole.

In an example embodiment, the rolling elements are rollers. In an example embodiment, the rolling elements include a group of rollers, for example rollers 106A/206A, circumferentially disposed about the inner ring and a group of rollers, for example rollers 106B/206B, circumferentially disposed about the inner ring and axially separated from the first group of rollers.

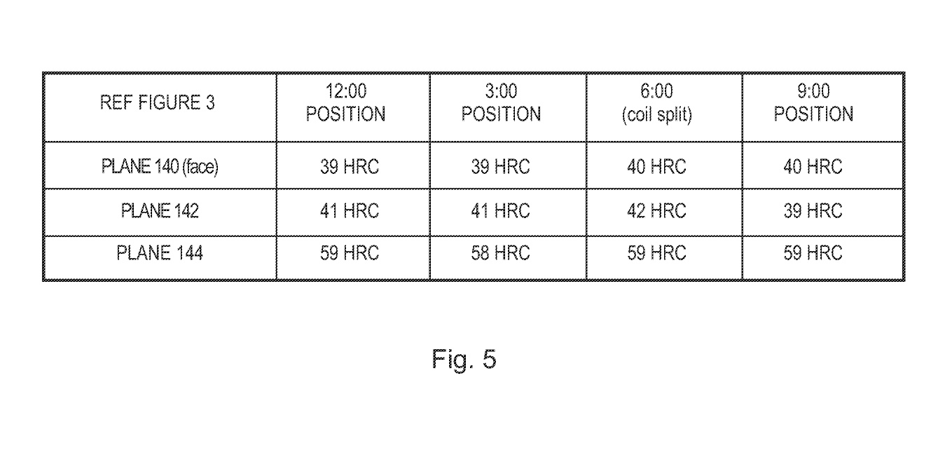

FIG. 5 is a table of hardness testing results for the inner race shown in FIG. 3.

Hardness testing was performed on inner race 102 along plane 140 (axially facing surface of axial end 114), plane 142 through slot 116, and plane 144 through portion 108 and surface 122. Sampling was performed at four evenly circumferentially spaced points in each plane (the second through fifth columns of FIG. 5). As shown in FIG. 5, advantageously, the Rockwell hardness for plane 144 was 58 to 59 HRC. This hardness is desirable for surface 122, which is in contact with rolling elements 106. Also advantageously, the respective hardnesses in planes 140 and 142 were reduced to between 39-42 HRC. The reduced hardness in planes 140 and 142 (portion 110) increases the ductility of portion 110 and reduces the likelihood of fracturing, cracking, or other failure of portion 110. For example, if outer portion 120 has a Rockwell hardness of 58-59 HRC, outer portion 120 is more likely to fail, for example, have segments of outer portion 120 separate from the remainder of inner ring 102, when pressure is applied to portion 120 during installation of snap ring 117, for example, applying pressure on outer portion 120 in axial direction 146. However, due to the increased ductility (lower hardness) of outer portion 120, outer portion 120 is able to flex sufficiently to avoid catastrophic failure. In like manner, increasing the ductility (reducing hardness) of outer portion 220 reduces the likelihood of failure of portion 210/220 when force is applied to outer portion 220, for example, when applying torque to fastener 217 to mount assembly 200.

It should be understood that other hardnesses are possible for portions 108 and 110 and portions 208 and 210. It should be understood that other differences of hardnesses are possible between portions 108 and 110 and portions 208 and 210.

Thus, the annealing of portions 110/210, which results in the hardness of portions 110/210 being less than the hardness of portions 108/208 advantageously resolves the problem of cracking or weakening of portions 110/210 during operations on portions 110/210, such as forming slot 116 or hole 216, or mounting of snap ring 117. At the same time, the greater hardness of portions 108/208, desirable because of the contact of portions 108/208 with rolling elements 106/206, is preserved. Further, the lesser hardness of portions 110/210 reduces the likelihood of cracking or fracturing during mounting and removal of assembly 100/200, service/repair work on assembly 100/200, or operational use of assembly 100/200.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. An inner ring for a bearing, comprising:
a first portion having a first hardness; and,
a second portion including:
an axial end of the inner ring with an axial circumferential edge;
a slot for receiving a mounting or fastening device, or a hole for receiving a mounting fastener;
an inner portion axially between the first portion and the slot or hole; and,
an outer portion axially between the slot or hole and the axial circumferential edge, wherein at least one of the inner or outer portions has a second hardness less than the first hardness.

2. The inner ring of claim 1, wherein each of the inner and outer portions has the second hardness.

3. The inner ring of claim 1, wherein the first portion includes a first surface arranged to receiving a plurality of rolling elements and having the first hardness.

4. The inner ring of claim 1, wherein the second portion includes:
second and third surfaces facing in opposite radial directions; and,
an interior portion radially aligned with and radially disposed between the second and third surfaces and having the second hardness.

5. The inner ring of claim 1, wherein the second portion includes second and third surfaces facing in opposite radial directions having the second hardness.

6. The inner ring of claim 1, wherein:
the first portion includes the slot; and,
the slot is bounded by one of the second or third surfaces.

7. The inner ring of claim 1, wherein:
the second portion includes the hole; and,
the hole connects the second and third surfaces.

8. The inner ring of claim 1, wherein the second portion includes:
the slot; and,
a radial portion radially aligned with the slot and having the second hardness.

9. The inner ring of claim 1, wherein:
the first hardness has a value of greater than 55 HRC on the Rockwell scale; and,
the second hardness has a value no greater than 45 HRC on the Rockwell scale.

10. A bearing assembly, comprising:
an inner ring including:
a first portion having a first hardness; and,
a second portion including:
an axial end of the inner ring with an axial circumferential edge;
a slot for receiving a snap ring or other mounting device, or a hole for receiving a mounting fastener;
an inner portion axially between the first portion and the slot or hole; and,
an outer portion axially between the slot or hole and the axial circumferential edge;
an outer ring; and,
a plurality of rolling elements in contact with the first portion and the outer ring and radially disposed between the first portion and the outer ring, wherein at least one of the inner or outer portions has a second hardness less than the first hardness.

11. The bearing assembly of claim 10, wherein each of the inner and outer portions has the second hardness.

12. The bearing assembly of claim 10, wherein the second portion includes:
the slot; and,
a radial portion radially aligned with the slot and having the second hardness.

13. The bearing assembly of claim 10, wherein the second portion includes second and third surfaces facing in opposite radial directions having the second hardness.

14. The bearing assembly of claim 10, wherein the second portion includes:
second and third surfaces facing in opposite radial directions; and,
an interior portion radially aligned with and radially disposed between the second and third surfaces and having the second hardness.

15. The bearing assembly of claim 10, wherein the plurality of rolling elements includes:
a first group of rollers circumferentially disposed about the inner ring; and,
a second group of rollers circumferentially disposed about the inner ring and axially separated from the first group of rollers.

16. A method of fabricating an inner ring, comprising:
forming the inner ring;
hardening the inner ring to a first hardness;
annealing a first portion of the inner ring to have a second hardness, less than the first hardness, while leaving a second portion of the inner ring with the first hardness; and,
forming in the first portion:
a slot for receiving a snap ring or other mounting device; or,
a hole for receiving a mounting fastener.

17. The method of claim 16, wherein the first portion includes an axial end of the inner race with an axial circumferential edge; and,

18. The method of claim 16, wherein the second portion includes a surface arranged to contact a plurality of rolling elements.

19. The method of claim 16, wherein:
the first portion includes first and second surfaces facing in opposite radial directions having the second hardness; and,
forming the slot includes forming the slot in the first or second surface.

20. The method of claim 16, wherein:
the first portion includes first and second surfaces facing in opposite radial directions having the second hardness; and,
forming the hole includes connecting the first and second surfaces with the hole.
